(19) United States
(12) Patent Application Publication
(10) Pub. No.: US 2026/0270794 A1
(43) Pub. Date: Sep. 10, 2026

(54) SYSTEMS AND METHODS FOR DYNAMIC NETWORK SLICE MAXIMUM DATA RATE ADJUSTMENT IN A WIRELESS NETWORK

(71) Applicant: Verizon Patent and Licensing Inc., Basking Ridge, NJ (US)

(72) Inventors: Violeta Cakulev, Milburn, NJ (US); Lixia Yan, Basking Ridge, NJ (US); Raquel Morera Sempere, Weehawken, NJ (US); Sudhakar Reddy Patil, Flower Mound, TX (US)

(73) Assignee: Verizon Patent and Licensing Inc., Basking Ridge, NJ (US)

(21) Appl. No.: 19/073,228

(22) Filed: Mar. 7, 2025

(51) Int. Cl. H04W 28/22; H04W 28/08

(52) U.S. Cl. CPC H04W 28/22; H04W 28/0925

(57) ABSTRACT

A system described herein may receive or determine a maximum aggregate data rate for a particular network slice of a wireless network, and may provide the maximum aggregate data rate to an information repository of the wireless network. The policy elements of the wireless network may obtain the maximum aggregate data rate from the information repository and implement the maximum aggregate data rate for the particular network slice. The policy elements may include one or more Policy Control Functions (“PCFs”) of the wireless network. The system may be external to the wireless network, and may provide the maximum aggregate data rate to a Network Exposure Function (“NEF”) of the wireless network. The maximum aggregate data rate may be determined based on network analytics information associated with the particular network slice.

### BACKGROUND

Wireless networks provide wireless connectivity to User Equipment (“UEs”), such as mobile telephones, tablets, Internet of Things (“IoT”) devices, Machine-to-Machine (“M2M”) devices, or the like. Wireless networks may implement different network slices, which may be associated with discrete sets of access policies, Quality of Service (“QoS”) parameters, or the like. In some implementations, different network elements, such as Network Function (“NF”) instances, may implement different network slices (e.g., a first NF instance of a particular type of NF may be associated with a first network slice, a second NF instance of the same particular type of NF may be associated with a second network slice, and so on). Network slices may be associated with a maximum data rate, which may reflect the maximum allowable data rate, bandwidth, throughput, etc. that may be utilized, in aggregate, by the network slices. For example, the maximum data rate for a particular network slice may indicate the maximum data rate that may be utilized by all flows, communication sessions, etc. that are associated with the particular network slice, across the entire wireless network.

### BRIEF DESCRIPTION OF THE DRAWINGS

FIG. 1 illustrates an example overview of one or more embodiments described herein;

FIG. 2 illustrates an example of a service received by a UE via a network before and after a network slice maximum data rate adjustment, in accordance with some embodiments;

FIG. 3 illustrates an example signal flow for automatically adjusting the maximum data rate for a given network slice, in accordance with some embodiments;

FIG. 4 illustrates an example signal flow for implementing an updated maximum data rate for a given network slice as initiated by an external device or system, in accordance with some embodiments;

FIG. 5 illustrates an example process for implementing a dynamically updated maximum data rate for a particular network slice, in accordance with some embodiments;

FIGS. 6 and 7 illustrate example environments in which one or more embodiments, described herein, may be implemented;

FIG. 8 illustrates an example arrangement of a radio access network (“RAN”), in accordance with some embodiments; and

FIG. 9 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Embodiments described herein provide for the dynamic adjustment of one or more parameters associated with one or more particular network slices implemented by a wireless network. As noted above, one or more network slices may be associated with a maximum data rate (also referred to as a Maximum Slice Data Rate (“MSDR”)), which may define an aggregate maximum data rate, throughput, bandwidth, etc. that may be utilized by such network slices (e.g., by all flows, communication sessions, etc. associated with the network slice). For example, if traffic demand for a given network slice exceeds the MSDR for the network slice, the wireless network may drop or reject traffic, such that data rate of the network slice does not exceed the MSDR for the network slice. In some embodiments, MSDR may refer to or may reflect a maximum uplink data rate, a maximum downlink data rate, a maximum uplink data rate and a separate maximum downlink data rate, or an aggregate uplink and downlink data rate.

Situations may arise in which the MSDR for a given network slice should be adjusted. For example, if traffic demand for the network slice exceeds, will exceed, is predicted to exceed, etc. the MSDR for the network slice, dropping or rejecting excess traffic may result in a degradation in performance of services provided via the network slice, a degradation in Quality of Experience (“QoE”) metrics of services provided via the network slice, or the like. As another example, if traffic demand for a network slice is below (e.g., is substantially below, will be below, or is predicted to be substantially below) the MSDR for the network slice, then reducing the MSDR for the network slice may free up resource allocations that may be used for other network slices, thus enhancing the overall efficiency of the wireless network. As such, as discussed below, embodiments may provide for the dynamic adjustment of the MSDR for one or more network slices in a wireless network, in order to preserve performance and QoE of the wireless network, while making efficient use of resources (e.g., processing resources, network resources, time, etc.) of the wireless network.

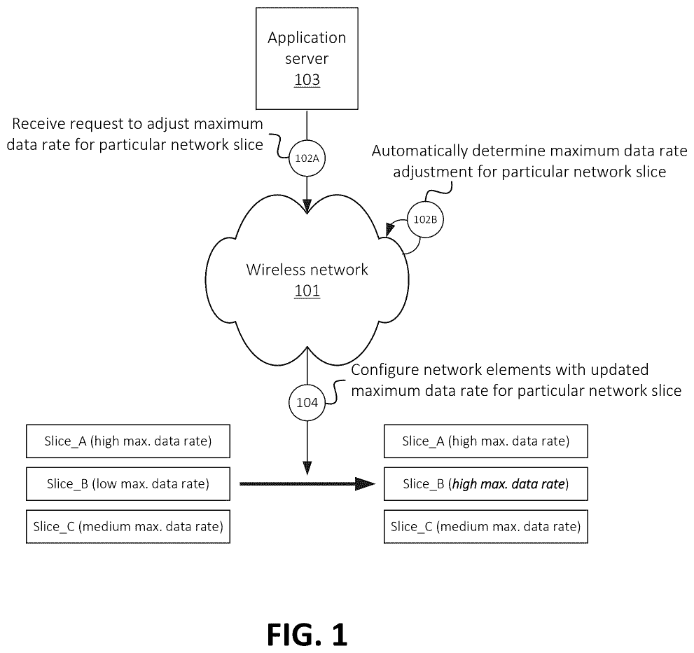

As shown in FIG. 1, for example, wireless network 101 may implement a set of network slices, referred to in this example as Slice_A, Slice_B, and Slice_C. Each network slice may be associated with a different maximum data rate (e.g., a different maximum aggregate data rate, a different MSDR, etc.). As noted above, the maximum data rate for a given slice may be a maximum data rate, throughput, bandwidth, or the like that is enforced or otherwise implemented by wireless network 101 across a given network slice. For example, the maximum data rate for Slice_A may reflect a maximum aggregate (e.g., cumulative) data rate for all flows, communication sessions, etc. associated with Slice_A (e.g., traffic sent and/or received by wireless network 101, where such traffic is associated with Slice_A). Similarly, the maximum data rate for Slice_B may reflect a maximum aggregate data rate for all flows, communication sessions, etc. associated with Slice_B, and the maximum data rate for Slice_C may reflect a maximum aggregate data rate for all flows, communication sessions, etc. associated with Slice_C. Although one maximum data rate is shown for each network slice, in some implementations, each network slice may be associated with multiple maximum data rates, such as a first maximum data rate for uplink traffic and a second maximum data rate for downlink traffic.

One or more elements of wireless network 101 may implement, enforce, etc. the maximum data rate for a given slice. For example, if the maximum data rate for a particular network slice is exceeded, or is predicted to be exceeded at some future time (e.g., based on actual or predicted network analytics and/or based on other factors), wireless network 101 may reject requests to establish communication sessions or flows via the particular network slice, modify Aggregate Maximum Bitrate (“AMBR”) thresholds for one or more UEs utilizing the particular network slice (e.g., AMBR thresholds for particular communication sessions or flows), and/or other suitable operations. In some embodiments, one or more Policy Control Functions (“PCFs”) of wireless network 101 may enforce or implement the maximum data rate for respective network slices of wireless network 101. In some embodiments, one or more other network elements of wireless network 101 may enforce or implement the maximum data rate for respective network slices.

In this example, assume that in an initial state (e.g., during a first timeframe), Slice_A is associated with a first maximum data rate (e.g., a “high” maximum data rate), Slice_B is associated with a second maximum data rate (e.g., a “low” maximum data rate), and Slice_C is associated with a third maximum data rate (e.g., a “medium” maximum data rate). The terms “high,” “medium,” and “low” are used here for sake of illustration. In practice, different identifiers, labels, values, etc. may be used to signify different maximum data rates for different network slices.

In accordance with some embodiments, wireless network 101 may receive (at 102A) a request to adjust the maximum data rate for a particular network slice (i.e., Slice_B, in this example). As shown, the request may be received from a device or system external to wireless network 101, such as application server 103. In one example embodiment, application server 103 may have registered with wireless network 101, such that application server 103 is authorized to request modifications to one or more particular network slices. For example, Slice_B may be a dedicated slice that is accessible to UEs associated with a particular organization or other entity, where application server 103 is also associated with the particular organization or entity (e.g., application server 103 may be an administrator system associated with such organization or entity).

As another example, wireless network 101 may automatically determine (at 102B) that the particular network slice should be adjusted. For example, as discussed below, wireless network 101 may monitor analytics information, such as performance information, QoS information, QoE information, or the like. The analytics information may be monitored on a per-flow or per-session basis, on a per-service basis, on a per-UE basis, and/or on some other suitable basis. In one example, wireless network 101 may determine (at 102B) that Service Level Agreements (“SLAs”) or other QoS parameters are not being met for one or more UEs receiving service via Slice_B, and that the maximum data rate for Slice_B should therefore be increased.

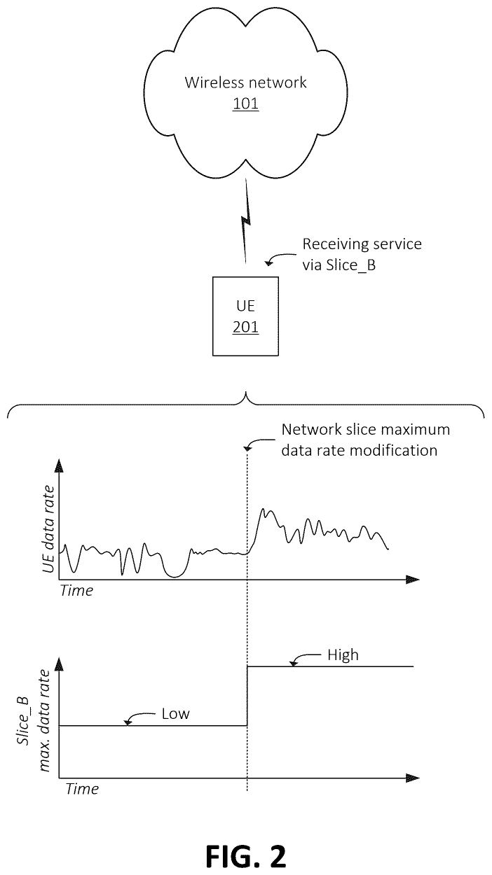

As another example, wireless network 101 may determine that SLAs or QoS parameters are being met with a significant margin, and that the maximum data rate for Slice_B should therefore be decreased in order to free up network resources (e.g., for other network slices) while minimally impacting or not impacting the performance or operation of Slice_B. That is, while FIG. 2 depicts a scenario in which the maximum data rate for Slice_B is increased, in practice other scenarios may occur in which the maximum data rate for Slice_B is decreased.

Based on receiving (at 102A) a request from application server 103, and/or based on determining (at 102B) an adjustment to the maximum data rate for the particular network slice, wireless network 101 may configure (at 104) one or more network elements (e.g., one or more PCFs and/or other suitable network elements) with the updated maximum data rate. In this example, the maximum data rate for Slice_B is adjusted from a particular maximum data rate (e.g., a “low” maximum data rate) to a different maximum data rate (e.g., a “high” maximum data rate). In some embodiments, one or more information repositories of wireless network 101, such as a Unified Data Repository (“UDR”), a Unified Data Management function (“UDM”), or the like, may maintain maximum data rate information for one or more network slices of wireless network 101, and may be notified of changes to such information (e.g., the UDR, UDM, etc. may be updated to indicate that Slice_B is no longer associated with the “low” maximum data rate and/or that Slice_B is now associated with the “high” maximum data rate). In some embodiments, one or more other network elements may perform one or more configuration operations. For example, a network management or provisioning system may instantiate additional NF instances, allocate additional resources, etc. for Slice_B to accommodate an increased maximum data rate for Slice_B, and/or may de-instantiate NF instances, de-allocate resources, etc. for Slice_B in situations where the maximum data rate for Slice_B is reduced.

FIG. 2 illustrates an example situation in which a particular UE 201 is connected to wireless network 101 via a particular network slice, and the maximum data rate for the network slice is modified (e.g., as discussed above). In this example, assume that UE 201 remains connected to wireless network 101 via the same network slice for the duration of time shown in the figure (e.g., Slice_B). As shown, when Slice_B is associated with a “low” maximum data rate, the data rate for UE 201 may be relatively low, and/or UE 201 may experience periods of time in which little or no traffic is sent or received by UE 201, which may be caused by factors such as high congestion of the network slice. In some situations, the relatively low data rate, periods of little or no traffic, or the like, may lead to performance issues that reduce the QoE, QoS, etc. of services received by UE 201 (e.g., communications with application servers or other UEs) via wireless network 101.

After the maximum data rate for the network slice is adjusted (e.g., as discussed above), the data rate of traffic sent and/or received by UE 201 may increase. For example, more resources may be available for the network slice to handle the traffic demand of UEs that receive services via the network slice. As another example, the increased maximum data rate for the network slice may include or may facilitate the increase in per-UE usage or bitrate limits (e.g., an AMBR threshold), such that UE 201 is granted authorization or priority to send and/or receive more traffic after the network slice maximum data rate modification.

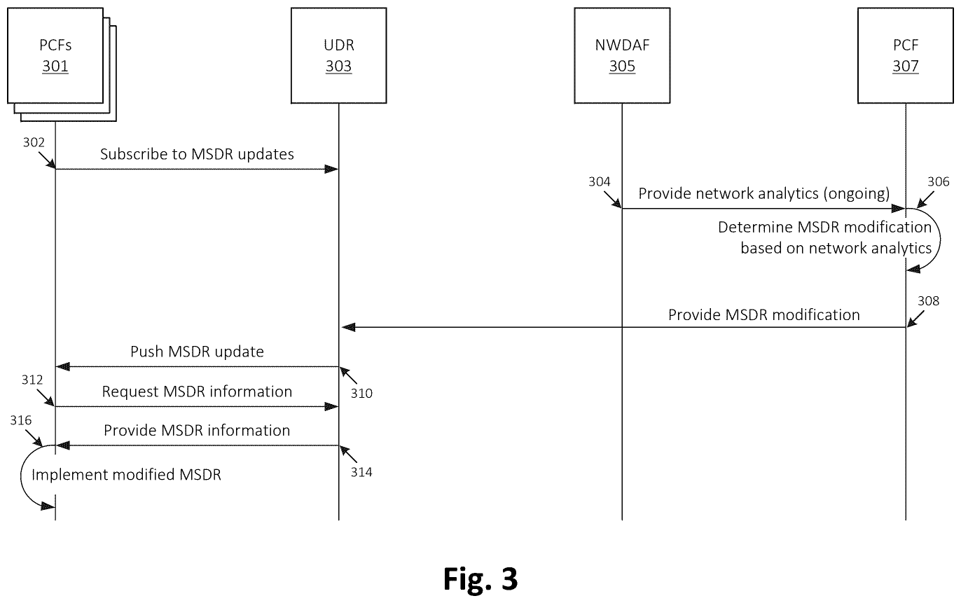

FIG. 3 illustrates an example signal flow for automatically adjusting the maximum data rate for a given network slice, in accordance with some embodiments. As shown, a set of PCFs 301 of wireless network 101 may subscribe (at 302) to maximum data rate updates (presented in the context MSDR updates in this figure and the subsequent figure) associated with one or more particular network slices. For example, subscribing to the maximum data rate updates for the particular network slice may be performed prior to a modification or configuration of the maximum data rate for the particular network slice. As one example, PCFs 301 may be a subset (e.g., fewer than all) of a set of PCFs implemented by wireless network 101. Such subset may be, for example, particular PCFs 301 that implement or maintain policies with respect to a particular network slice. PCFs 301 may also be referred to as “PCF instances,” inasmuch as PCFs 301 are all the same type of NF (e.g., where “PCF” is the type of NF), but are different instances of the same type of NF.

In this manner, in some embodiments, PCFs (e.g., PCF instances) that are not involved with the particular network slice (e.g., PCFs that do not implement or maintain policies with respect to the particular network slice) may forgo subscribing (at 302) to MSDR updates for the particular network slice, thus potentially reducing the amount of network traffic that would be consumed by pushing MSDR updates to PCFs that would not necessarily ultimately implement the MSDR updates. PCFs 301 may, for example, output (at 302) a subscription request to UDR 303, such that UDR 303 may automatically notify PCFs 301 of MSDR updates to the particular network slice when UDR 303 receives updates to such information.

As further shown, Network Data Analytics Function (“NWDAF”) 305 may provide (at 304) network analytics to a particular PCF 307. In some embodiments, the network analytics may include analytics specific to the particular network slice. The network analytics may include, for example, performance metrics (e.g., uplink and/or downlink throughput, uplink and/or downlink latency, and/or other suitable performance metrics collected and/or provided by NWDAF 305). PCF 307 may, for example, subscribe to such network analytics when creating a policy association associated with a particular network slice (e.g., which may be a part of a communication session establishment procedure between a particular UE 201 and wireless network 101 via the particular network slice). In some embodiments, NWDAF 305 may provide (at 304) the network analytics information on an ongoing basis, such as on a periodic or intermittent basis, on an event-based basis, on a “pull” basis (e.g., where PCF 307 issues requests for analytics information to NWDAF 305), and/or on some other ongoing basis. In some embodiments, PCF 307 may be a particular PCF out of the set of PCFs 301. In some embodiments, PCF 307 may be separate from PCFs 301.

In some embodiments, certain PCFs of wireless network 101 may be designated as PCFs that are authorized to modify the MSDR for one or more particular network slices, and other PCFs of wireless network 101 may not be designated as PCFs that are authorized to make such MSDR modifications. For instance, in this example, PCF 307 may be designated as a PCF that is authorized to modify the MSDR for the particular network slice, and/or some or all PCFs 301 may not be authorized to modify the MSDR for the particular network slice.

At some point, PCF 307 may determine (at 306) a modification to the MSDR, for the particular network slice, based on the received network analytics. For example, PCF 307 may determine, based on the network analytics, that one or more QoS thresholds, QoE thresholds, performance thresholds, or the like, are not being met (or are in danger of potentially not being met) with respect to the particular network slice (e.g., with respect to one or more particular UEs or groups of UEs connected via the particular network slice, with respect to one or more particular services received via the particular network slice, or the like). PCF 307 may, for example, compute or otherwise determine the modified MSDR in order to mitigate or remediate potential issues caused by the QoS thresholds, QoE thresholds, performance thresholds, etc. not being met. In some embodiments, artificial intelligence/machine learning (“AI/ML”) techniques may be used (e.g., by NWDAF 305, PCF 307, and/or some other suitable device or system) in order to identify that such thresholds are not being met, or are predicted to not be met at some future time. Similarly, in some embodiments, NWDAF 305 and/or PCF 307 may utilize AI/ML techniques in order to determine a particular modified MSDR that will mitigate or remediate such issues.

PCF 307 may accordingly provide (at 308) the modified MSDR to UDR 303. UDR 303 may accordingly maintain the MSDR for the particular network slice, such that other NFs of wireless network 101 (e.g., “consumer” NFs) may access the MSDR for the particular network slice. In some embodiments, UDR 303 may “push” or otherwise provide (at 310) the updated MSDR to PCFs 301 that have previously subscribed (at 302) to MSDR updates for the particular network slice. As another example, PCFs 301 (and/or other NFs of wireless network 101) may request (at 312) MSDR information for the particular network slice, and UDR 303 may provide (at 314) the requested MSDR information.

PCFs 301 may accordingly implement (at 316) the updated MSDR for the particular network slice. As noted above, implementing an increased (e.g., higher) MSDR may include allowing new communication sessions or policy associations to be established with respect to the particular network slice, increasing AMBR thresholds for UEs accessing the particular network slice, and/or otherwise increasing the maximum data rate for the particular network slice. On the other hand, implementing a decreased (e.g., lower) MSDR may include rejecting new communication sessions or policy associations from being established with respect to the particular network slice, decreasing AMBR thresholds for UEs accessing the particular network slice, and/or otherwise decreasing the maximum data rate or usage for the particular network slice.

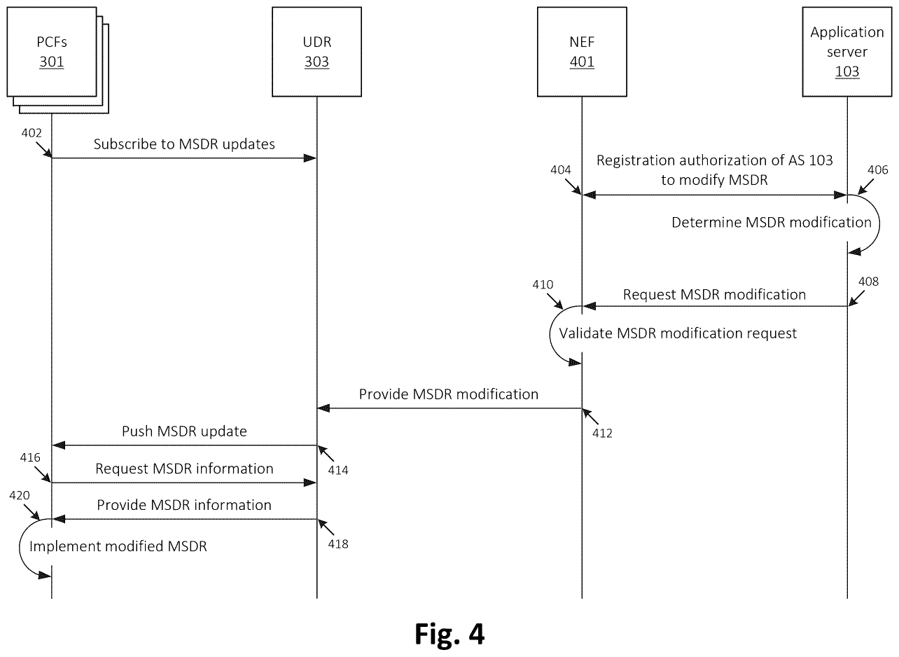

FIG. 4 illustrates an example signal flow for implementing an updated MSDR adjustment initiated by an external device or system (e.g., external to wireless network 101). Some of the operations shown in FIG. 4 are similar to those shown in FIG. 3, and descriptions of such operations are not repeated below in the interest of brevity. As shown in FIG. 4, one or more PCFs 301 of wireless network 101 may subscribe (at 402) to MSDR updates, such as MSDR updates for one or more particular network slices. As additionally shown, application server 103 may register (at 404) with NEF 401. For example, application server 103 may perform or participate in a registration procedure, authentication procedure, etc. in which NEF 401 maintains information indicating that application server 103 is authorized to modify the MSDR for a given slice. In practice, the authorization may include or may be based on certain policies or conditions, such as authorization to modify the MSDR only at certain times (e.g., times of day, days of week, etc.), authorization to modify the MSDR only at certain minimum intervals (e.g., at least a threshold duration of time between MSDR modifications, in order to avoid overloading wireless network 101 with excessive MSDR modification requests), and/or other policies or conditions.

Application server 103 may, at some point, determine (at 406) an MSDR modification (e.g., may compute a different MSDR than a current MSDR, or may otherwise determine an MSDR for the particular network slice). For example, application server 103 may monitor QoS metrics, QoE metrics, performance metrics, etc. of services provided by application server 103 to one or more UEs, and may determine that the MSDR should be increased (e.g., in order to meet QoS thresholds, QoE thresholds, performance thresholds, etc.) or decreased (e.g., in order to decrease an amount of network resources that are reserved or allocated for a particular network slice while not impacting the QoS, QoE, performance, etc. of such services).

Application server 103 may accordingly request (at 408) an MSDR modification. The request may include, for example, an identification of the particular network slice (e.g., an Network Slice Selection Assistance Information (“NSSAI”) value and/or some other suitable slice identifier). In some embodiments, the MSDR modification request may include an indication of a value to which the MSDR should be modified, and/or may specify an amount or percentage by which a current MSDR should be changed (e.g., increased by 10%, decreased by 20%, etc.). In some embodiments, the request may include additional information, such as authentication credentials (e.g., one or more authentication tokens, keys, encrypted values, or the like).

NEF 401 may determine whether the MSDR modification request is valid. For example, NEF 401 may determine whether authentication credentials included in the request are valid, whether application server 103 is authorized to request the MSDR modification, etc. In this example, assume that NEF 401 validates (at 410) the MSDR modification request as a valid MSDR modification request. NEF 401 may accordingly provide (at 412) the modified MSDR to UDR 303, which may push (at 414) the MSDR update to PCFs 301. Additionally, or alternatively, as discussed above, the updated MSDR information may be available to PCFs 301 and/or other NFs that request (at 416) the MSDR information (e.g., UDR 303 may provide (at 418) the updated MSDR information to such PCFs 301 and/or other NFs). As discussed above, PCFs 301 may implement (at 420) the modified MSDR, which may include accepting or rejecting communication session or policy association requests, increasing or decreasing per-UE AMBR values, or the like.

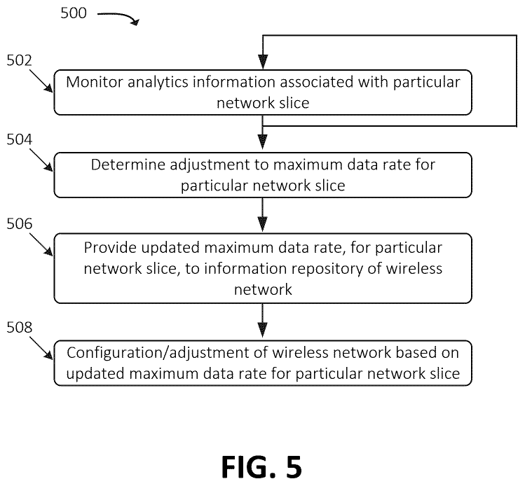

FIG. 5 illustrates an example process 500 for implementing a dynamically updated maximum data rate for a particular network slice. In some embodiments, some or all of process 500 may be performed by one or more NFs of wireless network 101, such as a particular PCF 307. In some embodiments, one or more other devices may perform some or all of process 500 in concert with, and/or in lieu of, PCF 307.

As shown, process 500 may include monitoring (at 502) analytics information associated with a particular network slice. As discussed above, for example, PCF 307 may receive network analytics information from NWDAF 305 or some other suitable device or system. The network analytics information may include performance metrics, QoS metrics, QoE metrics, or the like, associated with the particular network slice. For example, the analytics information may pertain to one or more communication sessions that are associated with the particular network slice, one or more services received by one or more UEs via the particular network slice, or the like.

Process 500 may further include determining (at 504) an adjustment to the maximum data rate for the particular network slice. For example, in situations where the particular network slice is congested (e.g., approaching, meeting, or exceeding the maximum data rate), services provided via the particular network slice may be impacted, such as with increased latency, reduced throughput, dropped traffic, rejection of new communication sessions, or the like. Increasing the maximum data rate for the particular network slice may alleviate or eliminate such issues.

On the other hand, in situations where the particular network slice is underutilized (e.g., an actual aggregate data rate associated with the particular network slice is substantially below the maximum data rate for the particular network slice), network resources allocated to the particular network slice may be reallocated to other network slices or otherwise freed up. Decreasing the maximum data for the particular network slice may allow for such resources to be reallocated or otherwise freed up.

Process 500 may additionally include providing (at 506) an updated maximum data rate, for the particular network slice, to an information repository of wireless network 101. For example, as discussed above, PCF 307 may provide the updated maximum data rate (e.g., an updated MSDR) to UDR 303. In this manner, UDR 303 may make the updated maximum data rate available to one or more other NFs of wireless network 101, such as one or more PCFs 301 (e.g., PCFs 301 that enforce or otherwise maintain policies associated with the particular network slice) or other NFs of wireless network 101.

Accordingly, one or more elements of wireless network 101 may be configured or adjusted (at 508) based on the updated maximum data rate. For example, one or more PCFs 301 may request maximum data rate information (e.g., may “pull” the maximum data rate information) from UDR 303, and/or the maximum data rate information may be pushed (e.g., automatically provided when such information is received) to PCFs 301 by UDR 303.

In some embodiments, the information maintained by UDR 303 may be accessed by a network management or provisioning system of wireless network 101, which may instantiate or “spin up” additional instances of one or more NFs in order to accommodate an increased maximum data rate for the particular network slice, or which my otherwise provide additional resources such that the increased maximum data rate for the particular network slice is able to be met. As another example, the network management or provisioning system of wireless network 101 may de-instantiate instances of one or more NFs in situations where the maximum data rate for the particular network slice is reduced, such as NF instances that are not needed in order to meet the reduced maximum data rate for the particular network slice.

Although process 500 is presented in the context of being performed by PCF 307, one or more operations of process 500 may be performed by some other device or system, such as a device or system that is external to wireless network 101 (e.g., application server 103). For example, application server 103 may monitor (at 502) analytics information associated with services provided by application server 103 and/or some other associated device or system (e.g., one or more application servers, content streaming platforms, databases, or the like), such as voice call services, videoconferencing services, content streaming services, gaming services, augmented reality (“AR”) services, or the like. As noted above, application server 103 may be associated with an organization, entity, etc. that is authorized to access the particular network slice (e.g., provide service to UEs via the particular network slice), that is authorized to monitor analytics or to receive analytics information associated with the particular network slice, and/or that is otherwise authorized to modify the maximum data rate for the particular network slice. Accordingly, as discussed above, providing (at 506) an updated maximum data rate for the particular network slice may include providing the updated maximum data rate via NEF 401 and/or some other suitable interface or communication pathway.

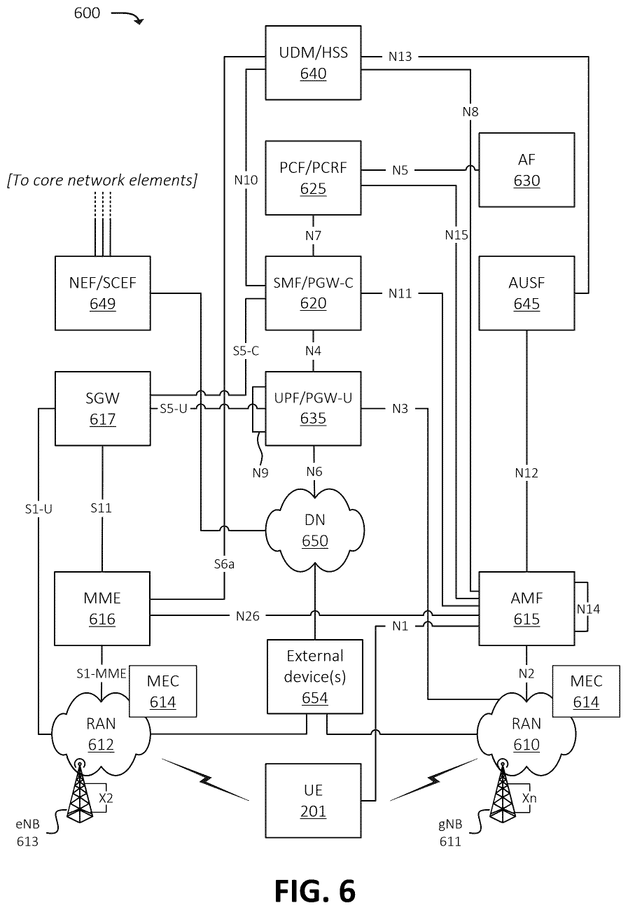

FIG. 6 illustrates an example environment 600, in which one or more embodiments may be implemented. In some embodiments, environment 600 may correspond to a Fifth Generation (“5G”) network, and/or may include elements of a 5G network. In some embodiments, environment 600 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). In some embodiments, portions of environment 600 may represent or may include a 5G core (“5GC”). As shown, environment 600 may include UE 201, RAN 610 (which may include one or more Next Generation Node Bs (“gNBs”) 611), RAN 612 (which may include one or more evolved Node Bs (“eNBs”) 613), and various network functions such as Access and Mobility Management Function (“AMF”) 615, Mobility Management Entity (“MME”) 616, Serving Gateway (“SGW”) 617, Session Management Function (“SMF”)/Packet Data Network (“PDN”) Gateway (“PGW”)-Control plane function (“PGW-C”) 620, PCF/Policy Charging and Rules Function (“PCRF”) 625, Application Function (“AF”) 630, User Plane Function (“UPF”)/PGW-User plane function (“PGW-U”) 635, Unified Data Management (“UDM”)/Home Subscriber Server (“HSS”) 640, Authentication Server Function (“AUSF”) 645, and Network Exposure Function (“NEF”)/Service Capability Exposure Function (“SCEF”) 649. Environment 600 may also include one or more networks, such as Data Network (“DN”) 650. Environment 600 may include one or more additional devices or systems communicatively coupled to one or more networks (e.g., DN 650), such as one or more external devices 654.

The example shown in FIG. 6 illustrates one instance of each network component or function (e.g., one instance of SMF/PGW-C 620, PCF/PCRF 625, UPF/PGW-U 635, UDM/HSS 640, and/or AUSF 645). In practice, environment 600 may include multiple instances of such components or functions. For example, in some embodiments, environment 600 may include multiple “slices” of a core network, where each slice includes a discrete and/or logical set of network functions (e.g., one slice may include a first instance of AMF 615, SMF/PGW-C 620, PCF/PCRF 625, and/or UPF/PGW-U 635, while another slice may include a second instance of AMF 615, SMF/PGW-C 620, PCF/PCRF 625, and/or UPF/PGW-U 635). The different slices may provide differentiated levels of service, such as service in accordance with different Quality of Service (“QoS”) parameters.

The quantity of devices and/or networks, illustrated in FIG. 6, is provided for explanatory purposes only. In practice, environment 600 may include additional devices and/or networks, fewer devices and/or networks, different devices and/or networks, or differently arranged devices and/or networks than illustrated in FIG. 6. For example, while not shown, environment 600 may include devices that facilitate or enable communication between various components shown in environment 600, such as routers, modems, gateways, switches, hubs, etc. In some implementations, one or more devices of environment 600 may be physically integrated in, and/or may be physically attached to, one or more other devices of environment 600. Alternatively, or additionally, one or more of the devices of environment 600 may perform one or more network functions described as being performed by another one or more of the devices of environment 600.

Additionally, one or more elements of environment 600 may be implemented in a virtualized and/or containerized manner. For example, one or more of the elements of environment 600 may be implemented by one or more Virtualized Network Functions (“VNFs”), Cloud-Native Network Functions (“CNFs”), etc. In such embodiments, environment 600 may include, may implement, and/or may be communicatively coupled to an orchestration platform that provisions hardware resources, installs containers or applications, performs load balancing, and/or otherwise manages the deployment of such elements of environment 600. In some embodiments, such orchestration and/or management of such elements of environment 600 may be performed by, or in conjunction with, the open-source Kubernetes® application programming interface (“API”) or some other suitable virtualization, containerization, and/or orchestration system.

Elements of environment 600 may interconnect with each other and/or other devices via wired connections, wireless connections, or a combination of wired and wireless connections. Examples of interfaces or communication pathways between the elements of environment 600, as shown in FIG. 6, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 6, such as Service-Based Interfaces (“SBIs”), including an Namf interface, an Nudm interface, an Npcf interface, an Nupf interface, an Nnef interface, an Nsmf interface, and/or one or more other SBIs. In some embodiments, environment 600 may be, may include, may be implemented by, and/or may be communicatively coupled to wireless network 101.

UE 201 may include a computation and communication device, such as a wireless mobile communication device that is capable of communicating with RAN 610, RAN 612, and/or DN 650. UE 201 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an Internet of Things (“IoT”) device (e.g., a sensor, a smart home appliance, a wearable device, a programmable logic controller or other industrial controller, a Machine-to-Machine (“M2M”) device, or the like), a Fixed Wireless Access (“FWA”) device, or another type of mobile computation and communication device. UE 201 may send traffic to and/or receive traffic (e.g., user plane traffic) from DN 650 via RAN 610, RAN 612, and/or UPF/PGW-U 635.

RAN 610 may be, or may include, a 5G RAN that implements a 5G RAT and that includes one or more base stations (e.g., one or more gNBs 611), via which UE 201 may communicate with one or more other elements of environment 600. UE 201 may communicate with RAN 610 via an air interface (e.g., as provided by gNB 611). For instance, RAN 610 may receive traffic (e.g., user plane traffic such as voice call traffic, data traffic, messaging traffic, etc.) from UE 201 via the air interface, and may communicate the traffic to UPF/PGW-U 635 and/or one or more other devices or networks. Further, RAN 610 may receive signaling traffic, control plane traffic, etc. from UE 201 via the air interface, and may communicate such signaling traffic, control plane traffic, etc. to AMF 615 and/or one or more other devices or networks. Additionally, RAN 610 may receive traffic intended for UE 201 (e.g., from UPF/PGW-U 635, AMF 615, and/or one or more other devices or networks) and may communicate the traffic to UE 201 via the air interface.

RAN 612 may be, or may include, an LTE RAN that implements an LTE RAT and that includes one or more base stations (e.g., one or more eNBs 613), via which UE 201 may communicate with one or more other elements of environment 600. UE 201 may communicate with RAN 612 via an air interface (e.g., as provided by eNB 613). For instance, RAN 612 may receive traffic (e.g., user plane traffic such as voice call traffic, data traffic, messaging traffic, signaling traffic, etc.) from UE 201 via the air interface, and may communicate the traffic to UPF/PGW-U 635 (e.g., via SGW 617) and/or one or more other devices or networks. Further, RAN 612 may receive signaling traffic, control plane traffic, etc. from UE 201 via the air interface, and may communicate such signaling traffic, control plane traffic, etc. to MME 616 and/or one or more other devices or networks. Additionally, RAN 612 may receive traffic intended for UE 201 (e.g., from UPF/PGW-U 635, MME 616, SGW 617, and/or one or more other devices or networks) and may communicate the traffic to UE 201 via the air interface.

One or more RANs of environment 600 (e.g., RAN 610 and/or RAN 612) may include, may implement, and/or may otherwise be communicatively coupled to one or more edge computing devices, such as one or more Multi-Access/Mobile Edge Computing (“MEC”) devices (referred to sometimes herein simply as a “MECs”) 614. MECs 614 may be co-located with wireless network infrastructure equipment of RANs 610 and/or 612 (e.g., one or more gNBs 611 and/or one or more eNBs 613, respectively). Additionally, or alternatively, MECs 614 may otherwise be associated with geographical regions (e.g., coverage areas) of wireless network infrastructure equipment of RANs 610 and/or 612. In some embodiments, one or more MECs 614 may be implemented by the same set of hardware resources, the same set of devices, etc. that implement wireless network infrastructure equipment of RANs 610 and/or 612. In some embodiments, one or more MECs 614 may be implemented by different hardware resources, a different set of devices, etc. from hardware resources or devices that implement wireless network infrastructure equipment of RANs 610 and/or 612. In some embodiments, MECs 614 may be communicatively coupled to wireless network infrastructure equipment of RANs 610 and/or 612 (e.g., via a high-speed and/or low-latency link such as a physical wired interface, a high-speed and/or low-latency wireless interface, or some other suitable communication pathway).

MECs 614 may include hardware resources (e.g., configurable or provisionable hardware resources) that may be configured to provide services and/or otherwise process traffic to and/or from UE 201, via RAN 610 and/or 612. For example, RAN 610 and/or 612 may route some traffic from UE 201 (e.g., traffic associated with one or more particular services, applications, application types, etc.) to a respective MEC 614 instead of to core network elements of 600 (e.g., UPF/PGW-U 635). MEC 614 may accordingly provide services to UE 201 by processing such traffic, performing one or more computations based on the received traffic, and providing traffic to UE 201 via RAN 610 and/or 612. MEC 614 may include, and/or may implement, some or all of the functionality described above with respect to UPF/PGW-U 635, AF 630, one or more application servers, and/or one or more other devices, systems, VNFs, CNFs, etc. In this manner, ultra-low latency services may be provided to UE 201, as traffic does not need to traverse links (e.g., backhaul links) between RAN 610 and/or 612 and the core network.

AMF 615 may include one or more devices, systems, VNFs, CNFs, etc., that perform operations to register UE 201 with the 5G network, to establish bearer channels associated with a session with UE 201, to hand off UE 201 from the 5G network to another network, to hand off UE 201 from the other network to the 5G network, manage mobility of UE 201 between RANs 610 and/or gNBs 611, and/or to perform other operations. In some embodiments, the 5G network may include multiple AMFs 615, which communicate with each other via the N14 interface (denoted in FIG. 6 by the line marked “N14” originating and terminating at AMF 615).

MME 616 may include one or more devices, systems, VNFs, CNFs, etc., that perform operations to register UE 201 with the EPC, to establish bearer channels associated with a session with UE 201, to hand off UE 201 from the EPC to another network, to hand off UE 201 from another network to the EPC, manage mobility of UE 201 between RANs 612 and/or eNBs 613, and/or to perform other operations.

SGW 617 may include one or more devices, systems, VNFs, CNFs, etc., that aggregate traffic received from one or more eNBs 613 and send the aggregated traffic to an external network or device via UPF/PGW-U 635. Additionally, SGW 617 may aggregate traffic received from one or more UPF/PGW-Us 635 and may send the aggregated traffic to one or more eNBs 613. SGW 617 may operate as an anchor for the user plane during inter-eNB handovers and as an anchor for mobility between different telecommunication networks or RANs (e.g., RANs 610 and 612).

SMF/PGW-C 620 may include one or more devices, systems, VNFs, CNFs, etc., that gather, process, store, and/or provide information in a manner described herein. SMF/PGW-C 620 may, for example, facilitate the establishment of communication sessions on behalf of UE 201. In some embodiments, the establishment of communications sessions may be performed in accordance with one or more policies provided by PCF/PCRF 625.

PCF/PCRF 625 may include one or more devices, systems, VNFs, CNFs, etc., that aggregate information to and from the 5G network and/or other sources. PCF/PCRF 625 may receive information regarding policies and/or subscriptions from one or more sources, such as subscriber databases and/or from one or more users (such as, for example, an administrator associated with PCF/PCRF 625).

AF 630 may include one or more devices, systems, VNFs, CNFs, etc., that receive, store, and/or provide information that may be used in determining parameters (e.g., quality of service parameters, charging parameters, or the like) for certain applications. In some embodiments, AF 630 may include, may implement, may be implemented by, and/or may otherwise be associated with application server 103.

UPF/PGW-U 635 may include one or more devices, systems, VNFs, CNFs, etc., that receive, store, and/or provide data (e.g., user plane data). For example, UPF/PGW-U 635 may receive user plane data (e.g., voice call traffic, data traffic, etc.), destined for UE 201, from DN 650, and may forward the user plane data toward UE 201 (e.g., via RAN 610, SMF/PGW-C 620, and/or one or more other devices). In some embodiments, multiple instances of UPF/PGW-U 635 may be deployed (e.g., in different geographical locations), and the delivery of content to UE 201 may be coordinated via the N9 interface (e.g., as denoted in FIG. 6 by the line marked “N9” originating and terminating at UPF/PGW-U 635). Similarly, UPF/PGW-U 635 may receive traffic from UE 201 (e.g., via RAN 610, RAN 612, SMF/PGW-C 620, and/or one or more other devices), and may forward the traffic toward DN 650. In some embodiments, UPF/PGW-U 635 may communicate (e.g., via the N4 interface) with SMF/PGW-C 620, regarding user plane data processed by UPF/PGW-U 635.

UDM/HSS 640 and AUSF 645 may include one or more devices, systems, VNFs, CNFs, etc., that manage, update, and/or store, in one or more memory devices associated with AUSF 645 and/or UDM/HSS 640, profile information associated with a subscriber. In some embodiments, UDM/HSS 640 may include, may implement, may be communicatively coupled to, and/or may otherwise be associated with some other type of repository or database, such as a Unified Data Repository (“UDR”). AUSF 645 and/or UDM/HSS 640 may perform authentication, authorization, and/or accounting operations associated with one or more UEs 201 and/or one or more communication sessions associated with one or more UEs 201.

DN 650 may include one or more wired and/or wireless networks. For example, DN 650 may include an Internet Protocol (“IP”)-based PDN, a wide area network (“WAN”) such as the Internet, a private enterprise network, and/or one or more other networks. UE 201 may communicate, through DN 650, with data servers, other UEs 201, and/or to other servers or applications that are coupled to DN 650. DN 650 may be connected to one or more other networks, such as a public switched telephone network (“PSTN”), a public land mobile network (“PLMN”), and/or another network. DN 650 may be connected to one or more devices, such as content providers, applications, web servers, and/or other devices, with which UE 201 may communicate.

External devices 654 may include one or more devices or systems that communicate with UE 201 via DN 650 and one or more elements of 600 (e.g., via UPF/PGW-U 635). External devices 654 may include, for example, one or more application servers 103, content provider systems, web servers, or the like. External devices 654 may, for example, implement “server-side” applications that communicate with “client-side” applications executed by UE 201. External devices 654 may provide services to UE 201 such as gaming services, videoconferencing services, messaging services, email services, web services, and/or other types of services. Operations described above with respect to a given external device 654 (e.g., in accordance with some embodiments) may be performed by a single device, by a cloud computing system, by one or more devices that implement a virtualized or containerized environment, a collection of devices, etc.

In some embodiments, external devices 654 may communicate with one or more elements of environment 600 (e.g., core network elements) via NEF/SCEF 649. NEF/SCEF 649 include one or more devices, systems, VNFs, CNFs, etc. that provide access to information, APIs, and/or other operations or mechanisms of one or more core network elements to devices or systems that are external to the core network (e.g., to external device 654 via DN 650). NEF/SCEF 649 may maintain authorization and/or authentication information associated with such external devices or systems, such that NEF/SCEF 649 is able to provide information, that is authorized to be provided, to the external devices or systems. For example, a given external device 654 may request particular information associated with one or more core network elements. NEF/SCEF 649 may authenticate the request and/or otherwise verify that external device 654 is authorized to receive the information, and may request, obtain, or otherwise receive the information from the one or more core network elements. In some embodiments, NEF/SCEF 649 may include, may implement, may be implemented by, may be communicatively coupled to, and/or may otherwise be associated with a Security Edge Protection Proxy (“SEPP”), which may perform some or all of the functions discussed above. External device 654 may, in some situations, subscribe to particular types of requested information provided by the one or more core network elements, and the one or more core network elements may provide (e.g., “push”) the requested information to NEF/SCEF 649 (e.g., in a periodic or otherwise ongoing basis).

In some embodiments, external devices 654 may communicate with one or more elements of RAN 610 and/or 612 via an API or other suitable interface. For example, a given external device 654 may provide instructions, requests, etc. to RAN 610 and/or 612 to provide one or more services via one or more respective MECs 614. In some embodiments, such instructions, requests, etc. may include QoS parameters, Service Level Agreements (“SLAs”), etc. (e.g., maximum latency thresholds, minimum throughput thresholds, etc.) associated with the services.

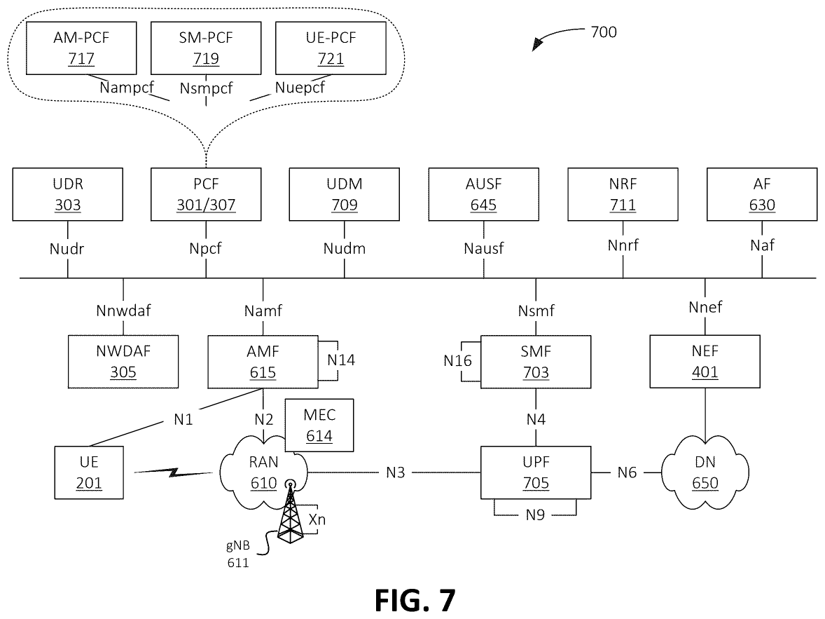

FIG. 7 illustrates another example environment 700, in which one or more embodiments may be implemented. In some embodiments, environment 700 may correspond to a 5G network, and/or may include elements of a 5G network. In some embodiments, environment 700 may correspond to a 5G SA architecture. In some embodiments, environment 700 may include a 5GC, in which 5GC network elements perform one or more operations described herein.

As shown, environment 700 may include UE 201, RAN 610 (which may include one or more gNBs 611 or other types of wireless network infrastructure) and various network functions, which may be implemented as VNFs, CNFs, etc. Such network functions may include AMF 615, SMF 703, UPF 705, one or more PCFs (e.g., one or more PCFs 301 and/or 307, referred to as “PCF 301/307 ” or “PCFs 301/307”), UDM 709, AUSF 645, Network Repository Function (“NRF”) 711, AF 630, UDR 303, and NEF 401. Environment 700 may also include or may be communicatively coupled to one or more networks, such as DN 650.

The example shown in FIG. 7 illustrates one instance of each network component or function (e.g., one instance of SMF 703, UPF 705, PCF 301/307, UDM 709, AUSF 645, etc.). In practice, environment 700 may include multiple instances of such components or functions. For example, in some embodiments, environment 700 may include multiple “slices” of a core network, where each slice includes a discrete and/or logical set of network functions (e.g., one slice may include a first instance of SMF 703, PCF 301/307, UPF 705, etc., while another slice may include a second instance of SMF 703, PCF 301/307, UPF 705, etc.). Additionally, or alternatively, one or more of the network functions of environment 700 may implement multiple network slices. The different slices may provide differentiated levels of service, such as service in accordance with different QoS parameters.

The quantity of devices and/or networks, illustrated in FIG. 7, is provided for explanatory purposes only. In practice, environment 700 may include additional devices and/or networks, fewer devices and/or networks, different devices and/or networks, or differently arranged devices and/or networks than illustrated in FIG. 7. For example, while not shown, environment 700 may include devices that facilitate or enable communication between various components shown in environment 700, such as routers, modems, gateways, switches, hubs, etc. In some implementations, one or more devices of environment 700 may be physically integrated in, and/or may be physically attached to, one or more other devices of environment 700. Alternatively, or additionally, one or more of the devices of environment 700 may perform one or more network functions described as being performed by another one or more of the devices of environment 700.

Elements of environment 700 may interconnect with each other and/or other devices via wired connections, wireless connections, or a combination of wired and wireless connections. Examples of interfaces or communication pathways between the elements of environment 700, as shown in FIG. 7, may include interfaces shown in FIG. 7 and/or one or more interfaces not explicitly shown in FIG. 7. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 700 may communicate via a service-based architecture (“SBA”), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 615), an Nudm interface (e.g., indicating communications to be routed to UDM 709), an Npcf interface, an Nupf interface, an Nnef interface, an Nsmf interface, an Nnrf interface, an Nudr interface, an Naf interface, and/or one or more other SBIs. In some embodiments, environment 700 may be, may include, may be implemented by, and/or may be communicatively coupled to wireless network 101.

UPF 705 may include one or more devices, systems, VNFs, CNFs, etc., that receive, route, process, and/or forward traffic (e.g., user plane traffic). As discussed above, UPF 705 may communicate with UE 201 via one or more communication sessions, such as PDU sessions. Such PDU sessions may be associated with a particular network slice or other suitable QoS parameters, as noted above. UPF 705 may receive downlink user plane traffic (e.g., voice call traffic, data traffic, etc. destined for UE 201) from DN 650, and may forward the downlink user plane traffic toward UE 201 (e.g., via RAN 610). In some embodiments, multiple UPFs 705 may be deployed (e.g., in different geographical locations), and the delivery of content to UE 201 may be coordinated via the N9 interface. Similarly, UPF 705 may receive uplink traffic from UE 201 (e.g., via RAN 610), and may forward the traffic toward DN 650. In some embodiments, UPF 705 may implement, may be implemented by, may be communicatively coupled to, and/or may otherwise be associated with UPF/PGW-U 635. In some embodiments, UPF 705 may communicate (e.g., via the N4 interface) with SMF 703, regarding user plane data processed by UPF 705 (e.g., to provide analytics or reporting information, to receive policy and/or authorization information, etc.).

PCF 301/307 may include one or more devices, systems, VNFs, CNFs, etc., that aggregate, derive, generate, etc. policy information associated with the 5GC and/or UEs 201 that communicate via the 5GC and/or RAN 610. PCF 301/307 may receive information regarding policies and/or subscriptions from one or more sources, such as subscriber databases (e.g., UDM 709, UDR 303, etc.), and/or from one or more users such as, for example, an administrator associated with PCF 301/307. In some embodiments, the functionality of PCF 301/307 may be split into multiple network functions or subsystems, such as access and mobility PCF (“AM-PCF”) 717, session management PCF (“SM-PCF”) 719, UE PCF (“UE-PCF”) 721, and so on. Such different “split” PCFs may be associated with respective SBIs (e.g., AM-PCF 717 may be associated with an Nampcf SBI, SM-PCF 719 may be associated with an Nsmpcf SBI, UE-PCF 721 may be associated with an Nuepcf SBI, and so on) via which other network functions may communicate with the split PCFs. The split PCFs may maintain information regarding policies associated with different devices, systems, and/or network functions.

NRF 711 may include one or more devices, systems, VNFs, CNFs, etc. that maintain routing and/or network topology information associated with the 5GC. For example, NRF 711 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 303 may include one or more devices, systems, VNFs, CNFs, etc. that provide user and/or subscriber information, based on which PCF 301/307 and/or other elements of environment 700 may determine access policies, QoS policies, charging policies, or the like. In some embodiments, UDR 303 may receive such information from UDM 709 and/or one or more other sources.

NEF 401 include one or more devices, systems, VNFs, CNFs, etc. that provide access to information, APIs, and/or other operations or mechanisms of the 5GC to devices or systems that are external to the 5GC. NEF 401 may maintain authorization and/or authentication information associated with such external devices or systems, such that NEF 401 is able to provide information, that is authorized to be provided, to the external devices or systems. Such information may be received from other network functions of the 5GC (e.g., as authorized by an administrator or other suitable entity associated with the 5GC), such as SMF 703, UPF 705, a charging function (“CHF”) of the 5GC, and/or other suitable network function. NEF 401 may communicate with external devices or systems (e.g., external devices 654) via DN 650 and/or other suitable communication pathways.

While environment 700 is described in the context of a 5GC, as noted above, environment 700 may, in some embodiments, include or implement one or more other types of core networks. For example, in some embodiments, environment 700 may be or may include a converged packet core, in which one or more elements may perform some or all of the functionality of one or more 5GC network functions and/or one or more EPC network functions. For example, in some embodiments, AMF 615 may include, may implement, may be implemented by, and/or may otherwise be associated with MME 616; SMF 703 may include, may implement, may be implemented by, and/or may otherwise be associated with SGW 617; PCF 301/307 may include, may implement, may be implemented by, and/or may otherwise be associated with a PCRF (e.g., PCF/PCRF 625); NEF 401 may include, may implement, may be implemented by, and/or may otherwise be associated with a SCEF (e.g., NEF/SCEF 649); and so on.

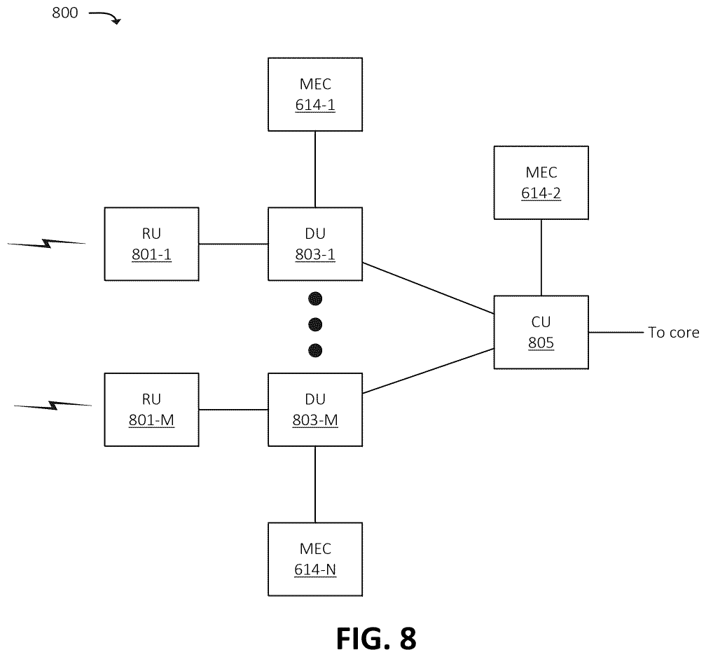

FIG. 8 illustrates an example RAN environment 800, which may be included in and/or implemented by one or more RANs (e.g., RAN 610 or some other RAN). In some embodiments, a particular RAN 610 may include one RAN environment 800. In some embodiments, a particular RAN 610 may include multiple RAN environments 800. In some embodiments, RAN environment 800 may correspond to a particular gNB 611 of RAN 610. In some embodiments, RAN environment 800 may correspond to multiple gNBs 611. In some embodiments, RAN environment 800 may correspond to one or more other types of base stations of one or more other types of RANs. As shown, RAN environment 800 may include Central Unit (“CU”) 805, one or more Distributed Units (“DUs”) 803-1 through 803-M (referred to individually as “DU 803,” or collectively as “DUs 803”), and one or more Radio Units (“RUs”) 801-1 through 801-M (referred to individually as “RU 801,” or collectively as “RUs 801”).

CU 805 may communicate with a core of a wireless network (e.g., may communicate with one or more of the devices or systems described above with respect to FIG. 7, such as AMF 615 and/or UPF 705) and/or some other device or system such as MEC 614. In the uplink direction (e.g., for traffic from UEs 201 to a core network), CU 805 may aggregate traffic from DUs 803, and forward the aggregated traffic to the core network. In some embodiments, CU 805 may receive traffic according to a given protocol (e.g., Radio Link Control (“RLC”) traffic) from DUs 803, and may perform higher-layer processing (e.g., may aggregate/process RLC packets and generate Packet Data Convergence Protocol (“PDCP”) packets based on the RLC packets) on the traffic received from DUs 803.

CU 805 may receive downlink traffic (e.g., traffic from the core network, traffic from a given MEC 614, etc.) for a particular UE 201, and may determine which DU(s) 803 should receive the downlink traffic. DU 803 may include one or more devices that transmit traffic between a core network (e.g., via CU 805) and UE 201 (e.g., via a respective RU 801). DU 803 may, for example, receive traffic from RU 801 at a first layer (e.g., physical (“PHY”) layer traffic, or lower PHY layer traffic), and may process/aggregate the traffic to a second layer (e.g., upper PHY and/or RLC). DU 803 may receive traffic from CU 805 at the second layer, may process the traffic to the first layer, and provide the processed traffic to a respective RU 801 for transmission to UE 201.

RU 801 may include hardware circuitry (e.g., one or more RF transceivers, antennas, radios, and/or other suitable hardware) to communicate wirelessly (e.g., via an RF interface) with one or more UEs 201, one or more other DUs 803 (e.g., via RUs 801 associated with DUs 803), and/or any other suitable type of device. In the uplink direction, RU 801 may receive traffic from UE 201 and/or another DU 803 via the RF interface and may provide the traffic to DU 803. In the downlink direction, RU 801 may receive traffic from DU 803, and may provide the traffic to UE 201 and/or another DU 803.

One or more elements of RAN environment 800 may, in some embodiments, be communicatively coupled to one or more MECs 614. For example, DU 803-1 may be communicatively coupled to MEC 614-1, DU 803-M may be communicatively coupled to MEC 614-N, CU 805 may be communicatively coupled to MEC 614-2, and so on. MECs 614 may include hardware resources (e.g., configurable or provisionable hardware resources) that may be configured to provide services and/or otherwise process traffic to and/or from UE 201, via a respective RU 801.

For example, DU 803-1 may route some traffic, from UE 201, to MEC 614-1 instead of to a core network via CU 805. MEC 614-1 may process the traffic, perform one or more computations based on the received traffic, and may provide traffic to UE 201 via RU 801-1. As discussed above, MEC 614 may include, and/or may implement, some or all of the functionality described above with respect to UPF 705, AF 630, and/or one or more other devices, systems, VNFs, CNFs, etc. In this manner, ultra-low latency services may be provided to UE 201, as traffic does not need to traverse DU 803, CU 805, links between DU 803 and CU 805, and an intervening backhaul network between RAN environment 800 and the core network.

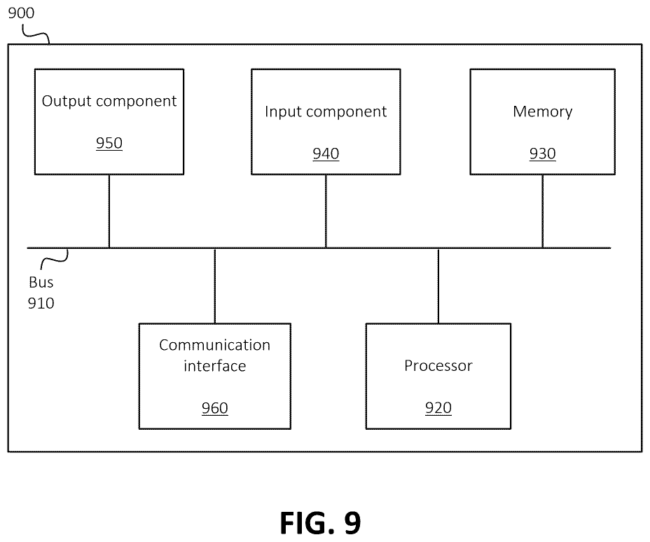

FIG. 9 illustrates example components of device 900. One or more of the devices described above may include one or more devices 900. Device 900 may include bus 910, processor 920, memory 930, input component 940, output component 950, and communication interface 960. In another implementation, device 900 may include additional, fewer, different, or differently arranged components.

Bus 910 may include one or more communication paths that permit communication among the components of device 900. Processor 920 may include a processor, microprocessor, a set of provisioned hardware resources of a cloud computing system, a graphics processing unit (“GPU”), a GPU-based processing unit, a neural processing unit (“NPU”), or other suitable type of hardware that interprets and/or executes instructions (e.g., processor-executable instructions). In some embodiments, processor 920 may be or may include one or more hardware processors. Memory 930 may include any type of dynamic storage device that may store information and instructions for execution by processor 920, and/or any type of non-volatile storage device that may store information for use by processor 920.

Input component 940 may include a mechanism that permits an operator to input information to device 900 and/or other receives or detects input from a source external to input component 940, such as a touchpad, a touchscreen, a keyboard, a keypad, a button, a switch, a microphone or other audio input component, etc. In some embodiments, input component 940 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 950 may include a mechanism that outputs information to the operator, such as a display, a speaker, one or more light emitting diodes (“LEDs”), etc.

Communication interface 960 may include any transceiver-like mechanism that enables device 900 to communicate with other devices and/or systems (e.g., via RAN 610, RAN 612, DN 650, etc.). For example, communication interface 960 may include an Ethernet interface, an optical interface, a coaxial interface, or the like. Communication interface 960 may include a wireless communication device, such as an infrared (“IR”) receiver, a Bluetooth® radio, or the like. The wireless communication device may be coupled to an external device, such as a cellular radio, a remote control, a wireless keyboard, a mobile telephone, etc. In some embodiments, device 900 may include more than one communication interface 960. For instance, device 900 may include an optical interface, a wireless interface, an Ethernet interface, and/or one or more other interfaces.

Device 900 may perform certain operations relating to one or more processes described above. Device 900 may perform these operations in response to processor 920 executing instructions, such as software instructions, processor-executable instructions, etc. stored in a computer-readable medium, such as memory 930. A computer-readable medium may be defined as a non-transitory memory device. A memory device may include space within a single physical memory device or spread across multiple physical memory devices. The instructions may be read into memory 930 from another computer-readable medium or from another device. The instructions stored in memory 930 may be processor-executable instructions that cause processor 920 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-5), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set. Concepts described above may be embodied by, for example, a device, devices, a system, systems, a method, methods, a non-transitory computer-readable medium, and/or non-transitory computer-readable media, as provided for in the claims.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
receive or determine a maximum aggregate data rate for a particular network slice of a wireless network; and
provide the maximum aggregate data rate to an information repository of the wireless network,
wherein one or more policy elements of the wireless network obtain the maximum aggregate data rate from the information repository and implement the maximum aggregate data rate for the particular network slice.

2. The device of claim 1, wherein the maximum aggregate data rate for the particular network slice includes a Maximum Slice Data Rate (“MSDR”) for the particular network slice.

3. The device of claim 1, wherein providing the maximum aggregate data rate to an information repository of the wireless network includes providing the maximum aggregate data rate to a Unified Data Repository (“UDR”) of the wireless network.

4. The device of claim 1, wherein the one or more policy elements of the wireless network include one or more Policy Control Function (“PCF”) instances of the wireless network.

5. The device of claim 1, wherein the one or more policy elements each output a request to the information repository for maximum aggregate data rate associated with the particular network slice prior to the maximum aggregate data rate being provided to the information repository, wherein the information repository pushes the maximum aggregate data rate to the one or more policy elements after receiving the maximum aggregate data rate.

6. The device of claim 5, wherein the request to the information repository, from each policy element of the one or more policy elements, includes a subscription request that indicates the particular network slice.

7. The device of claim 1, wherein the device includes a Network Exposure Function (“NEF”) of the wireless network, and wherein receiving the maximum aggregate data rate for the particular network slice includes receiving the maximum aggregate data rate from a device that is external to the wireless network.

8. A non-transitory computer-readable medium, storing a plurality of processor-executable instructions to:
receive or determine a maximum aggregate data rate for a particular network slice of a wireless network; and
provide the maximum aggregate data rate to an information repository of the wireless network,
wherein one or more policy elements of the wireless network obtain the maximum aggregate data rate from the information repository and implement the maximum aggregate data rate for the particular network slice.

9. The non-transitory computer-readable medium of claim 8, wherein the maximum aggregate data rate for the particular network slice includes a Maximum Slice Data Rate (“MSDR”) for the particular network slice.

10. The non-transitory computer-readable medium of claim 8, wherein providing the maximum aggregate data rate to an information repository of the wireless network includes providing the maximum aggregate data rate to a Unified Data Repository (“UDR”) of the wireless network.

11. The non-transitory computer-readable medium of claim 8, wherein the one or more policy elements of the wireless network include one or more Policy Control Function (“PCF”) instances of the wireless network.

12. The non-transitory computer-readable medium of claim 8, wherein the one or more policy elements each output a request to the information repository for maximum aggregate data rate associated with the particular network slice prior to the maximum aggregate data rate being provided to the information repository, wherein the information repository pushes the maximum aggregate data rate to the one or more policy elements after receiving the maximum aggregate data rate.

13. The non-transitory computer-readable medium of claim 12, wherein the request to the information repository, from each policy element of the one or more policy elements, includes a subscription request that indicates the particular network slice.

14. The non-transitory computer-readable medium of claim 8, wherein receiving the maximum aggregate data rate for the particular network slice includes receiving, by a Network Exposure Function (“NEF”) of the wireless network, the maximum aggregate data rate from a device that is external to the wireless network.

15. A method, comprising:
receiving or determining a maximum aggregate data rate for a particular network slice of a wireless network; and
providing the maximum aggregate data rate to an information repository of the wireless network,
wherein one or more policy elements of the wireless network obtain the maximum aggregate data rate from the information repository and implement the maximum aggregate data rate for the particular network slice.

16. The method of claim 15, wherein the maximum aggregate data rate for the particular network slice includes a Maximum Slice Data Rate (“MSDR”) for the particular network slice.

17. The method of claim 15, wherein providing the maximum aggregate data rate to an information repository of the wireless network includes providing the maximum aggregate data rate to a Unified Data Repository (“UDR”) of the wireless network.

18. The method of claim 15, wherein the one or more policy elements of the wireless network include one or more Policy Control Function (“PCF”) instances of the wireless network.

19. The method of claim 15, wherein the one or more policy elements each output a subscription request to the information repository for maximum aggregate data rate associated with the particular network slice prior to the maximum aggregate data rate being provided to the information repository, wherein the information repository pushes the maximum aggregate data rate to the one or more policy elements after receiving the maximum aggregate data rate based on the subscription request from each policy element of the one or more policy elements.

20. The method of claim 15, wherein receiving the maximum aggregate data rate for the particular network slice includes receiving, by a Network Exposure Function (“NEF”) of the wireless network, the maximum aggregate data rate from a device that is external to the wireless network.
